(19) United States
(12) Patent Application Publication
(10) Pub. No.: US 2025/0054219 A1
(43) Pub. Date: Feb. 13, 2025

(54) IMAGE PROCESSING METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventor: Xinwei JIANG, Shenzhen (CN)

(21) Appl. No.: 18/830,291

(22) Filed: Sep. 10, 2024

Related U.S. Application Data
(63) Continuation of application No. PCT/CN2023/123514, filed on Oct. 9, 2023.

(30) Foreign Application Priority Data
Nov. 25, 2022 (CN) 202211493839.4

(51) Int. Cl. G06T 15/00

(52) U.S. Cl. CPC G06T 15/00

(57) ABSTRACT

This application provides an image processing method performed by an electronic device. The method includes: obtaining an initial value of a target material parameter of a target object; determining a photographing parameter of a photographed image of the target object; rendering the target object according to the initial value and the photographing parameter, to obtain a rendered image of the target object; determining difference information between the rendered image and the photographed image; adjusting the initial value according to the difference information, to obtain a target value of the target material parameter; and updating the rendered image of the target object by rendering the target object according to the target value.

### CROSS-REFERENCE TO RELATED APPLICATIONS

This application is a continuation application of PCT Patent Application No. PCT/CN2023/123514, entitled “IMAGE PROCESSING METHOD AND APPARATUS, DEVICE, STORAGE MEDIUM, AND PROGRAM PRODUCT” filed on Oct. 9, 2023, which claims priority to Chinese Patent Application No. 202211493839.4, entitled “IMAGE PROCESSING METHOD AND APPARATUS, DEVICE, STORAGE MEDIUM, AND PROGRAM PRODUCT” and filed with the China National Intellectual Property Administration on Nov. 25, 2022, both of which are incorporated herein by reference in their entirety.

### FIELD OF THE TECHNOLOGY

This application relates to the technical field of image processing, and in particular, to an image processing method and apparatus, a device, a storage medium, and a program product.

### BACKGROUND OF THE DISCLOSURE

With the development of science and technology, the application of image technology is more and more widely, for example, the image technology is applied to games, animation, or advertising.

Before an image is presented through the image technology, an object in the image need to be rendered. The process includes: setting a material parameter of an object in an image and rendering the object in the image according to the material parameter, to obtain the image. However, at present, material parameters of objects in an image are set manually, resulting in a low rendering efficiency and accuracy.

### SUMMARY

Embodiments of this application provide an image processing method and apparatus, a device, a storage medium, and a program product, which can solve the technical problem of the low rendering efficiency and accuracy caused by manually setting a value of a material parameter.

According to an aspect, an embodiment of this application provides an image processing method performed by an electronic device, the method including:
obtaining an initial value of a target material parameter of a target object;
determining a photographing parameter of a photographed image of the target object;
rendering the target object according to the initial value and the photographing parameter, to obtain a rendered image of the target object;
determining difference information between the rendered image and the photographed image;
adjusting the initial value according to the difference information, to obtain a target value of the target material parameter; and
updating the rendered image of the target object by rendering the target object according to the target value.

According to another aspect, an embodiment of this application further provides an electronic device, including a processor and a memory, the memory having a computer program stored therein, the computer program, when executed by the processor, causing the electronic device to implement the image processing method provided in the embodiments of this application.

According to another aspect, an embodiment of this application further provides a non-transitory computer-readable storage medium, the computer-readable storage medium having a computer program stored therein, the computer program, when executed by a processor of an electronic device, causing the electronic device to execute the image processing method provided in the embodiments of this application.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art may still derive other drawings from these accompanying drawings without creative efforts.

FIG. 1 is a schematic scene diagram of an image processing process according to an embodiment of this application.

FIG. 2 is a schematic flowchart of an image processing method according to an embodiment of this application.

FIG. 3 is a schematic flowchart of another image processing method according to an embodiment of this application.

FIG. 4 is a schematic diagram of a process of setting a material parameter according to an embodiment of this application.

FIG. 5 is a schematic diagram of the another process of setting a material parameter according to an embodiment of this application.

FIG. 6 is a schematic diagram of a method for optimizing a material parameter according to an embodiment of this application.

FIG. 7 is a schematic structural diagram of an image processing apparatus according to an embodiment of this application.

FIG. 8 is a schematic structural diagram of an electronic device according to an embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person skilled in the art based on the embodiments of this application without creative efforts fall within the protection scope of this application.

Embodiments of this application provide an image processing method and apparatus, a device, a storage medium, and a program product. The device may be an electronic device, the storage medium may be a computer storage medium, and the program product may be a computer program product. The image processing apparatus may be integrated in an electronic device, and the electronic device may be a server or a device such as a terminal.

The server may be an independent physical server, or a server cluster or distributed system composed of a plurality of physical servers, or may be a cloud server for providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform.

In addition, a plurality of servers may be grouped into a blockchain, and the servers are nodes on the blockchain.

The terminal may be a smartphone, a tablet, a laptop, a desktop computer, a smart sound box, a smart watch, a virtual reality device (VR), an augmented reality device (AR), or the like, but is not limited thereto. The terminal and the server may be directly or indirectly connected in a wired or wireless communication protocol, which is not limited in this application.

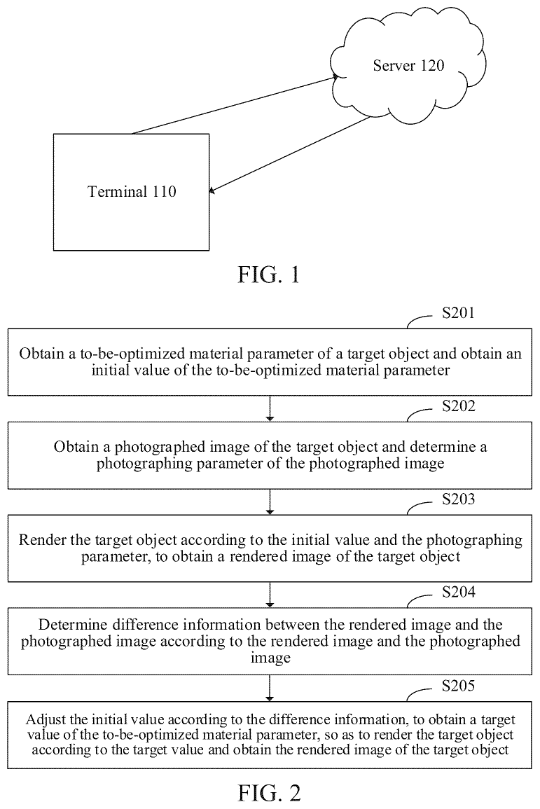

For example, FIG. 1 is a schematic scene diagram of an image processing process according to an embodiment of this application. A terminal 110 and a server 120 are included. As shown in FIG. 1, the server 120 obtains a target material parameter of a target object, performs initialization processing on the target material parameter, to obtain an initial value of the target material parameter, obtains a photographed image of the target object, determines a photographing parameter of the photographed image, renders the target object according to the initial value and the photographing parameter, to obtain a rendered image of the target object, determines difference information between the rendered image and the photographed image according to the rendered image and the photographed image, and optimizes (specifically, adjusts) the initial value according to the difference information, to obtain a target value of the target material parameter. The terminal 110 transmits a parameter obtaining request of the target object to the server 120, the server 120 returns the target value of the target material parameter to the terminal 110 according to the parameter obtaining request, and the terminal 110 renders the target object according to the target value, to obtain the rendered image of the target object.

The image processing method of the embodiments of this application may be applied to various scenarios of rendering an object. For example, the image processing method of the embodiments of this application may be used for rendering an object in a game, and the object in the game may be, for example, a game prop, a game character, or a game background. Still for example, the image processing method of the embodiments of this application may alternatively be used for rendering an object in animation, and the object in the animation may be a character, an animal, or a scenic spot.

In addition, “a plurality” in the embodiments of this application refers to two or more. In the embodiments of this application, “first” and “second” are used for distinguishing description, and cannot be understood as implying relative importance.

Detailed descriptions are separately provided below. A description order of the following embodiments is not used as a limitation on the priority order of the embodiments.

Nouns involved in this application are explained in the following.

Unreal engine: It refers to a framework composed of various tools required to write various games. Game developers can directly call various tools in an unreal engine to quickly make a game application without starting from scratch.

Render pipeline: It refers to an overall process of converting data from a 3D scene into a 2D image and finally displaying the 2D image on a screen. The render pipeline may include an application stage, a geometry stage, and a rasterization stage. The application stage refers to a process of obtaining scene data, and the scene data includes three-dimensional coordinates of a vertex, a light source, a camera position, a view cone, a material of each object, and the like. The geometry stage includes a process of calculating scene data, and the calculation process includes processes such as coordinates change, vertex coloring, projection change, and clipping. The rasterization stage includes processes of converting a 3D continuous object into discrete screen pixels and a process of determining colors of pixels of a screen according to illumination and material parameters.

In the embodiments of this application, the initial value and the photographing parameter of the target material parameter of the target object may be inputted to the render pipeline for rendering, so as to obtain the rendered image of the target object.

In this embodiment, for convenience of description, the image processing method of this application is described from the perspective of the image processing apparatus. The image processing apparatus is integrated in a terminal for detailed description below, that is, the terminal is used as an execution body for detailed description.

FIG. 2 is a schematic flowchart of an image processing method according to an embodiment of this application. The image processing method is by an electronic device, for example, performed by a terminal 110 or by a server 120, or by interaction between the terminal 110 and the server 120 in FIG. 1. The image processing method may include:

S201: Obtain a target material parameter of a target object and obtain an initial value of the target material parameter.

The target object may refer to an object in reality, and the target object may be a character, a pet, or a plant, or may alternatively be various products, for example, the target object may be a car paint or a stone.

The target object may exist in a form of a model in a renderer, and the model refers to a graph composed of points, lines, or surfaces without information such as colors and textures.

When the target object is a player corresponding to a game, after the target object is rendered, a game character corresponding to the game player in the game may be obtained.

The material parameter refers to a parameter indicating a visual attribute of the target object, and the material parameter includes at least one of color, texture, smoothness, opacity, reflectivity, refractive index, or luminosity. Material parameter of different target objects may be different or may be the same.

For example, when target object is car paint, the material parameter of target object may refer to an opacity and a color of the car paint. Still for example, when the target object is a stone, the material parameter of the target object may refer to a smoothness and a color of the stone.

The material parameter may be indicated in two types, one is to indicate the material parameter of the target object by using a map, and the other one is to indicate the material parameter of the target object by using a specific numeral value.

In this embodiment of this application, when the material parameter is indicated by using a specific numeral value, the initial value of the target material parameter may be an initial value of the value. When the material parameter refers to a map, the initial value of the target material parameter may be an initial map.

The target material parameter of the target object may refer to an unoptimized material parameter among material parameters of the target object.

Before optimizing the target material parameter, the terminal may display a setting interface, and then obtain the target material parameter of the target object in response to a trigger operation of a user on the setting interface, that is, the initial value may be manually set by the user.

Alternatively, after obtaining the target material parameter, the terminal may initialize the target material parameter according to a preset initialization algorithm, to obtain the initial value of the target material parameter. In this case, the terminal automatically obtains the initial value of the target material parameter without manual setting by a user.

The preset initialization algorithm may be selected according to an actual situation. For example, a random initialization algorithm or a standard initialization algorithm may be used as the preset initialization algorithm in this embodiment of this application, which is not limited in this embodiment.

The terminal may obtain the initial value of the target material parameter when obtaining the target material parameter of the target object, or the terminal may obtain the initial value of the target material parameter after obtaining the target material parameter of the target object, which is not limited in this embodiment of this application.

S202: Obtain a photographed image of the target object and determine a photographing parameter of the photographed image.

The photographed image of the target object may include at least one image. The target object may be photographed using a same photographing parameter, to obtain a preset number of photographed images, or one photographed image may be photographed using a photographing parameter, which is not limited in this embodiment.

The photographing parameter of the photographed image may refer to a parameter when the target object is photographed. The photographing parameter may include at least one of a parameter of a photographing environment of the target object and a parameter of a camera. The parameter of the photographing environment of the target object may include weather of the photographing environment of the target object. The weather of the photographing environment includes rain, illuminance, light color, light source position, or the like. The parameter of the camera may include a position relationship between the camera and the target object, and the position relationship includes at least one of a distance and an angle.

The terminal may obtain the photographed image of target object by a camera of the terminal, or may alternatively obtain the photographed image of target object by a camera of another terminal, during which the another terminal transmits the photographed image to the terminal, so that the terminal obtains the photographed image of target object.

S203: Render the target object according to the initial value and the photographing parameter, to obtain a rendered image of the target object.

The rendering refers to a process of adjusting a model corresponding to an object to an image according to set environment, light, and material parameters.

The target object is rendered according to the initial value and the photographing parameter, to obtain the rendered image of the target object. Specifically, by using the photographing parameter, a rendering effect of rendering the target object according to the initial value is determined, and then the target object is rendered according to the rendering effect, so as to obtain the rendered image of the target object.

For example, the photographing parameter is an illuminance and the illuminance is 280 lux, the target material parameter is a color material parameter, an initial value of which may be (255,0,0), the terminal determines, through calculation, a rendering effect that the target object is rendered according to (255,0,0) under the 280 lux and then renders the target object according to rendering effect.

After obtaining the photographing parameter, the terminal may render the target object according to the initial value and the photographing parameter by using a renderer (for example, a render pipeline), to obtain the rendered image of the target object.

The renderer may be selected according to an actual situation. For example, the renderer may be a renderer in an unreal engine or a unity engine, which is not limited herein in the embodiments of this application.

S204: Determine difference information between the rendered image and the photographed image according to the rendered image and the photographed image.

The terminal may determine a ratio between an image parameter value of the rendered image and an image parameter value of the photographed image, and then use the ratio as the difference information between the rendered image and the photographed image. Alternatively, the terminal may alternately determine a difference between the image parameter value of the rendered image and the image parameter value of the photographed image, and then use the difference as the difference information between the rendered image and the photographed image.

The image parameter value of the rendered image may include all image parameter values of the rendered image, and the image parameter value of the photographed image may include all image parameter values of the photographed image; or the image parameter value of the rendered image may include only a rendering value corresponding to the target material parameter, and the image parameter value of the photographed image may include a real value corresponding to the target material parameter, which are not limited in this embodiment.

When the image parameter value of the rendered image includes the rendering value corresponding to the target material parameter and the image parameter value of the photographed image includes the real value corresponding to the target material parameter, the determining difference information between the rendered image and the photographed image according to the rendered image and the photographed image includes:
determining a corresponding rendering value of the target material parameter in the rendered image according to the rendered image;
determining a real value of the target material parameter in the photographed image according to the photographed image; and
determining the difference information between the rendered image and the photographed image according to the rendering value and the real value.

For example, the target material parameter refers to a color material parameter, a color value of the rendered image is A, a color value of the photographed image is B, and a difference between A and B is used as the difference information between the rendered image and the photographed image.

Some target material parameters consist of at least two sub-material parameters, for example, a color material parameter (RGB) includes an R parameter, a G parameter, and a B parameter, and the difference information between the rendered image and the photographed image may be determined according to sub-difference information of the sub-material parameters. In this case, the rendering value may include a rendering value of each sub-material parameter, the real value includes a real value of each sub-material parameter, and the determining the difference information between the rendered image and the photographed image according to the rendering value and the real value includes:
determining sub-difference information between the real value of the sub-material parameter and the rendering value of the sub-material parameter; and
determining the difference information between the rendered image and the photographed image according to pieces of sub-difference information.

After obtaining the pieces of sub-difference information of the sub-material parameters, the terminal may directly add the pieces of sub-difference information of the sub-material parameters, to obtain the difference information between the rendered image and the photographed image.

Alternatively, when the pieces of sub-difference information are differences between the real values of the sub-material parameters and the rendering values of the sub-material parameters, the terminal may first calculate squares of the pieces of sub-difference information, and then add the squares of the pieces of sub-difference information, to obtain the difference information between the rendered image and the photographed image. In this case, the difference information between the rendered image and the photographed image is determined according to Euclidean distances between the sub-material parameters.

In some embodiments, when the target material parameter is a color material parameter, to enable an obtained target value more accurate, the determining difference information between the rendered image and the photographed image according to the rendered image and the photographed image includes:
performing color space conversion on the rendered image, to obtain a converted rendered image;
performing color space conversion on the photographed image, to obtain a converted photographed image; and
determining difference information between the rendered image and the photographed image according to a converted rendered image and a converted photographed image.

The converted color space may be selected according to an actual situation. For example, a color space of the rendered image may be converted into a Lab color space or an HSV color space, which is not limited in this embodiment.

Usually, color information of the rendered image and color information of the photographed image are described by using an RGB color space. However, the calculation of the color information described by using the RGB color space is relatively complicated, and a user has a low sensitivity to the color information described by the RGB color space, resulting in a relatively low accuracy of the target value obtained according to the difference information. Therefore, in this embodiment of this application, the color space conversion is first performed on the rendered image, to obtain a converted rendered image, the color space conversion is performed on the photographed image, to obtain a converted photographed image, and then the difference information between the rendered image and the photographed image is determined according to the converted rendered image and the converted photographed image, so that the calculation amount in the process of determining the difference information is reduced and the accuracy of the target value obtained according to the difference information is improved.

S205: Adjust the initial value according to the difference information, to obtain a target value of the target material parameter, so as to render the target object according to the target value and obtain the rendered image of the target object.

If the difference information dissatisfies the preset condition, the initial value is optimized according to the difference information, so as to obtain the target value of the target material parameter; and if the difference information satisfies the preset condition, the initial value is used as the target value of the target material parameter.

When there are a plurality of photographed images and there are a plurality of rendered images, pieces of difference information between the rendered images and the photographed images may be added, to obtain total difference information, and the initial value is adjusted according to the total difference information, to obtain the target value of the target material parameter, or the initial value is adjusted according to an average of the total difference information, to obtain the target value of the target material parameter.

In the related art, the staff usually sets the value of the material parameters manually. In a process of setting a value of a material parameter, the staff usually relies on their subjective consciousness, to determine whether the rendered image rendered according to the material parameter conforms to a visual effect of a user. If not, the value of the material parameter is adjusted again, until the rendered image obtained by rendering according to the material parameter satisfies the visual effect of the user.

However, by manually setting the value of the material parameter by the staff, when there are a great number of material parameters to be set, the space of the material parameters may be greatly increased, and as a result, the manual workload is increased, and further the setting efficiency of values of the material parameters is reduced.

In addition, whether the rendered image obtained by rendering according to the material parameter conforms to the visual effect of the user is determined by the subjective consciousness of the staff, and determined results of different staff may be different, and as a result, the accuracy of the values of the material parameters is low.

However, in the embodiments of this application, the initial value of the target material parameter is optimized according to the difference information between the rendered image and the photographed image by using the same photographing parameter, so as to implement automatic setting of the value of the target material parameter, so that the setting efficiency of the value of the target material parameter is improved. In addition, whether the initial value of the target material parameter satisfies the preset condition is determined according to the difference information between the rendered image and the photographed image, so that the image obtained after the target object is rendered according to the target value of the target material parameter is as close to the photographed image as possible, without the subjective consciousness judgment by the staff, thereby improving the accuracy of the value of the target material parameter.

Because the value of the target material parameter can be quickly determined and the obtained value of the target material parameter is more accurate, the efficiency and accuracy of the rendered image obtained by rendering the target object according to the value of the target material parameter are high.

In some embodiments, to obtain the target value more accurately, the initial value can be optimized a plurality of times, and in this case, the adjusting the initial value according to the difference information, to obtain the target value of the target material parameter includes:
obtaining a preset condition;
if the difference information dissatisfies the preset condition, adjusting the initial value according to the difference information, to obtain a candidate value;
using the candidate value as the initial value of the target material parameter, and returning to perform the operation of rendering the target object according to the initial value and the photographing parameter; and
if the difference information satisfies the preset condition, using the initial value as the target value of the target material parameter.

For example, the initial value of the target material parameter is set to A1, the target object is rendered according to A1 and the photographing parameter, to obtain a rendered image m1 of the target object. Difference information d1 between the rendered image m1 and the photographed image is determined according to the rendered image m1 and the photographed image. If d1 is greater than a preset threshold, A1 is adjusted according to d1, to obtain a candidate value A2. The target object is rendered according to A2 and the photographing parameter, to obtain a rendered image m2 of the target object. Difference information d2 between the rendered image m2 and the photographed image is determined according to the rendered image m2 and the photographed image. If d2 is less than or equal to a preset threshold, A2 is used as the target value of the target material parameter. If d1 is less than or equal to the preset threshold, A1 is used as the target value of the target material parameter.

When the candidate value is used as the initial value of the target material parameter, the operation returned to perform may alternatively be the operation of obtaining a photographed image of the target object and determining a photographing parameter of the photographed image. In this case, the target material parameter may be optimized by using different photographed images.

Alternatively, when the number of adjustment times reaches a particular number, the value of the target material parameter may reach a convergence state. Therefore, in a process of adjusting the initial value a plurality of times, whether to stop the optimization may further be determined according to the number of adjustment times, that is, after obtaining the difference information, the current number of adjustment times is determined; if the current number of adjustment times is less than the preset number of adjustment times, the initial value is adjusted according to the difference information, to obtain a candidate value of the target material parameter; and if the current adjustment times is equal to the preset adjustment times, the initial value is used as the target value of the target material parameter.

In the embodiments of this application, the initial value is optimized a plurality of times according to the difference information, so as to improve the accuracy of the target value of the target material parameter.

In some other embodiments, the adjusting the initial value according to the difference information, to obtain the target value of the target material parameter includes:
determining an amount of change of the target material parameter according to the difference information; and
adjusting the initial value according to the amount of change, to obtain the target value of the target material parameter.

The amount of change of the target material parameter may refer to at least one of a change direction and a change magnitude of the target material parameter, and represent a change trend of the target material parameter. When the amount of change refers to the change direction of the target material parameter, the change direction may refer to a gradient direction of the target material parameter.

The change direction of the target material parameter may be determined according to a derivative obtained by derivation of the target material parameter according to the difference information, and the change magnitude of the target material parameter may be determined according to a magnitude of the difference information. For example, a greater magnitude of the difference information indicates a greater change magnitude of the target material parameter, and a smaller magnitude of the difference information indicates a smaller change magnitude of the target material parameter.

In some embodiments, the adjusting the initial value according to the amount of change, to obtain the target value of the target material parameter includes:
obtaining an optimization step corresponding to the target material parameter; and
adjusting the initial value according to the optimization step and the amount of change, to obtain the target value of the target material parameter.

In this embodiment, an optimization step (which may alternatively be referred to as an optimization hyperparameter) may be configured to determine an optimization degree corresponding to the initial value, so as to avoid missing an optimal value of the target material parameter.

The amount of change may be indicated by a numerical value. Multiple merging processing is performed on the optimization step and the amount of change, for example, the optimization step and the amount of change are multiplied, so as to obtain the optimization degree corresponding to the initial value, and then adding merging processing is performed on the optimization degree and the initial value, for example, the optimization degree and the initial value are added, so as to obtain the target value of the target material parameter.

The optimization step may be fixed, or the optimization step may be dynamically adjusted according to the difference information, which is not limited in this embodiment.

When the target object has at least two material parameters, the terminal may optimize the material parameters one by one, or optimize the material parameter simultaneously. When the material parameters are optimized one by one, the target material parameters may be first selected from the at least two material parameters of the target object, then a value of a candidate material parameter is fixed, values of the target material parameters are optimized, and the candidate material parameter is a parameter among material parameters except at least two target material parameters. In this case, rendering the target object according to the initial value and the photographing parameter, to obtain a rendered image of the target object includes:
rendering the target object according to the initial value, a set value corresponding to the candidate material parameter, and the photographing parameter, to obtain a rendered image of the target object.

Because the candidate material parameter may be an optimized parameter or an unoptimized parameter, the set value of the candidate material parameter may refer to an initial value of the candidate material parameter, or may refer to a target value of the candidate material parameter.

For example, the material parameter of the target object is a color material parameter and an opacity material parameter, and the terminal first optimizes the opacity material parameter as the target material parameter. In this case, the color material parameter has not been optimized, and therefore the set value of the color material parameter is the initial value of the color material parameter. When optimization of the opacity material parameter is completed, the target value of the opacity material parameter is obtained, and the color material parameter is optimized as the target material parameter. In this case, the opacity material parameter has been optimized, and therefore in the process of optimizing the color material parameter, the set value of the opacity material parameter is the target value of the opacity material parameter.

In other embodiments, the selecting the target material parameter from the at least two material parameters includes:
determining a correlation between the at least two material parameters; and
selecting the target material parameter from the at least two material parameters according to the correlation.

Because some material parameters may not affect each other, an optimization sequence of the material parameters may be determined according to a correlation between the material parameters, and then the target material parameter is selected from the at least two material parameters according to the optimization sequence, so that the accuracies of finally obtained values of the material parameters of the obtained target object are relatively high.

In the terminal, a material parameter that affects another parameter may be ranked in the later section in the optimization sequence, and a material parameter that does not affect another parameter may be ranked in the former section in the optimization sequence. For example, the material parameters include a color material parameter and an opacity material parameter, and the opacity material parameter does not affect the color material parameter. Therefore, the opacity material parameter may be optimized first, and then the color material parameter is optimized.

Because the terminal optimizes the material parameters one by one, when optimization of the target material parameters is completed, if there is still an unoptimized material parameter, the unoptimized material parameter needs to be optimized. In this case, after the adjusting the initial value according to the difference information, to obtain the target value of the target material parameter, the method further includes:
determining an optimization state of the material parameter; and
if the optimization state of the material parameter is a to-be-optimized state, returning to perform the operation of selecting the target material parameter from the at least two material parameters.

If the optimization state of the material parameter is a to-be-optimized state, the material parameter is an unoptimized parameter. Therefore, the material parameter needs to be optimized.

For example, the material parameters of the target object are a color material parameter and an opacity material parameter, and the terminal first optimizes the opacity material parameter as the target material parameter, that is, renders the target object according to an initial value of the opacity material parameter, the photographing parameter, and a set value of the color material parameter, to obtain the rendered image. If the difference information between the rendered image and the photographed image satisfies a preset condition, optimization of the opacity material parameter is completed. In this case, the color material parameter has not been optimized, and therefore the optimization state of the color material parameter is a to-be-optimized state. Therefore, the color material parameter is used as the target material parameter, and the value of the color material parameter continues to be optimized.

In this embodiment of this application, when there are at least two material parameters of the target object, the material parameters are optimized one by one, and therefore optimization of all material parameters of the target object is implemented.

When the at least two target material parameters are optimized simultaneously, the determining difference information between the rendered image and the photographed image according to the rendered image and the photographed image includes:
determining initial difference information between the rendered image and the photographed image for each target material parameter according to the rendered image and the photographed image; and
determining the difference information between the rendered image and the photographed image according to initial difference information corresponding to each target material parameter.

The terminal may determine initial difference information, of each target material parameter, between the rendered image and the photographed image according to a rendering value corresponding to each target material parameter in the rendered image and a real value corresponding to the photographed image, and then add pieces of initial difference information, to obtain the difference information between the rendered image and the photographed image.

Alternatively, when the at least two target material parameters are optimized simultaneously, the process of determining the difference information between the rendered image and the photographed image according to the rendered image and the photographed image may alternatively include:
determining a total rendering value of the rendered image according to the rendering value corresponding to each target material parameter in the rendered image;
determining a total real value of the photographed image according to the real value corresponding to each target material parameter in the photographed image; and
determining the difference information between the rendered image and the photographed image according to the total rendering value and the total real value.

When the at least two target material parameters are optimized simultaneously, the corresponding optimization steps of the material parameters may be different or may be the same, which is not limited herein in the embodiments of this application.

In this embodiment, all of the material parameters of the target object are optimized simultaneously to reduce the time required to obtain the target value of each material parameter, thereby further improving the speed of obtaining the target values of the material parameters of the target object.

After obtaining the target value of the target material parameter, the terminal may immediately render the target object by using the target value according to an actual application scenario, to obtain the rendered image of the target object. Alternatively, the terminal may render the target object by using the target value after a preset time interval according to an actual application scenario, to obtain the rendered image of the target object, which is not limited in this embodiment of this application.

After the target value of the target material parameter of the target object is obtained, corresponding target values of the target material parameter of the target object in different application scenarios may be the same. However, rendering effects after the target object is rendered by using the target value according to different application scenarios may be different.

For example, the application scenario includes a first application scenario and a second application scenario. The first application scenario is that moonlight shines on the ground and there is car paint on the ground, and the second application scenario is that sunlight shines on the ground and there is car paint on the ground. Then, the car paint in the first application scenario and the car paint in the second application scenario are rendered respectively according to the target values of the opacity material parameter and the target values of the color material parameter of the car paint, and the rendering effect of car paint in the first application scenario is different from the rendering effect in the second application scenario.

In view of the foregoing, in the embodiments of this application, by obtaining a target material parameter of a target object, performing initialization processing on the target material parameter, to obtain an initial value of the target material parameter, obtaining a photographed image of the target object, determining a photographing parameter of the photographed image, rendering the target object according to the initial value and the photographing parameter, to obtain a rendered image of the target object, determining difference information between the rendered image and the photographed image according to the rendered image and the photographed image, and adjusting the initial value according to the difference information, to obtain a target value of the target material parameter, the target object is rendered according to the target value, to obtain a rendered image of the target object, so that automatic optimization of the initial value of the target material parameter through the photographed image is implemented, the efficiency and accuracy of optimizing the target material parameter is improved, and further the efficiency and accuracy of rendering the target object according to the target value are improved.

According to the method described in the foregoing embodiment, the following further provides detailed descriptions by using an example.

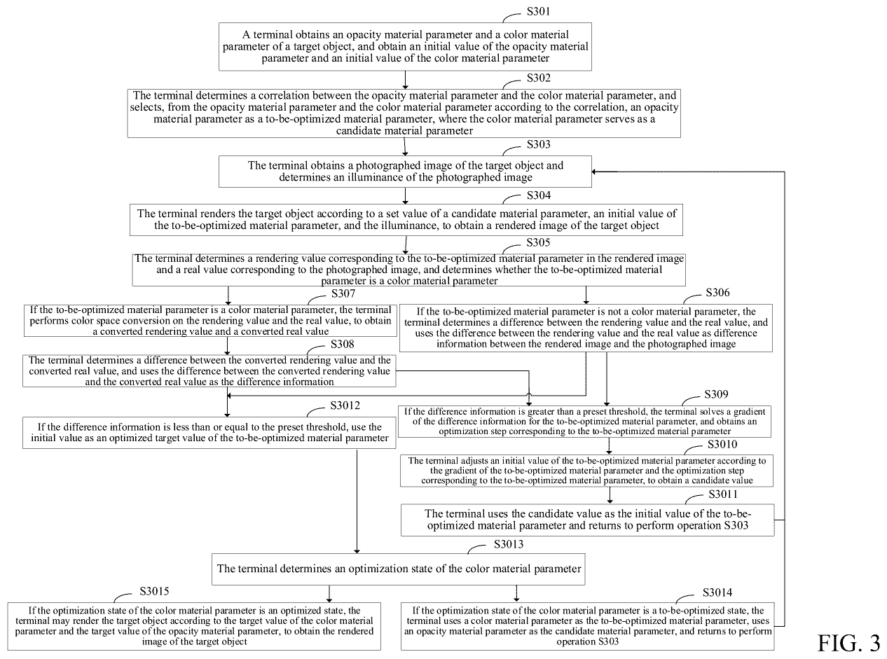

FIG. 3 is a schematic flowchart of an image processing method according to an embodiment of this application. The image processing method is executed by an electronic device, for example, executed by the terminal 110 in FIG. 1. The procedure of the image processing method may include:

S301: A terminal obtains an opacity material parameter and a color material parameter of a target object, and obtains an initial value of the opacity material parameter and an initial value of the color material parameter.

The opacity material parameter (Opacity) may be a scalar, for example, using a floating point type, and the color material parameter (Base Color) may be a three-dimensional vector. A process in which the terminal optimizes the material parameters may include a parameter setting part and a parameter optimization part.

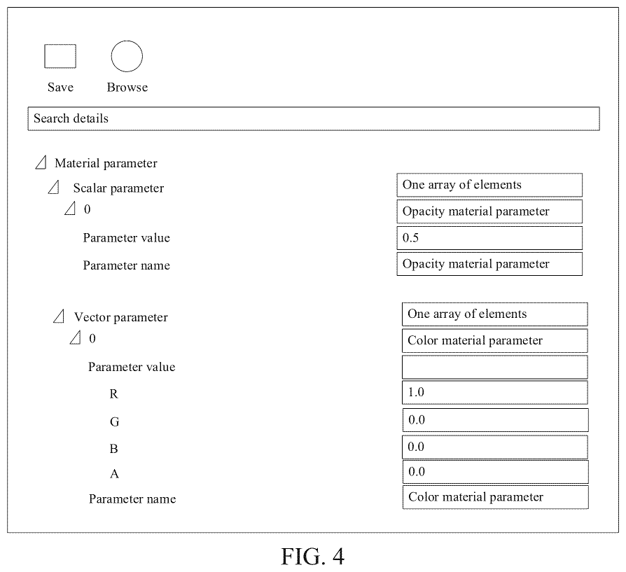

In the parameter setting process, the terminal may add a scalar parameter and a vector parameter in an unreal engine 4 (UE4). For example, a parameter setting interface of the unreal engine 4 is shown in FIG. 4 (a value of the parameter is an initial value of the material parameter), the terminal may create a material parameter collection (MPC) in the unreal engine 4, and then set the opacity material parameter and the color material parameter in the material parameter collection.

After setting the initial value of the opacity material parameter and the initial value of the color material parameter in the material parameter collection, the terminal inputs the material parameter collection to a renderer of the unreal engine 4.

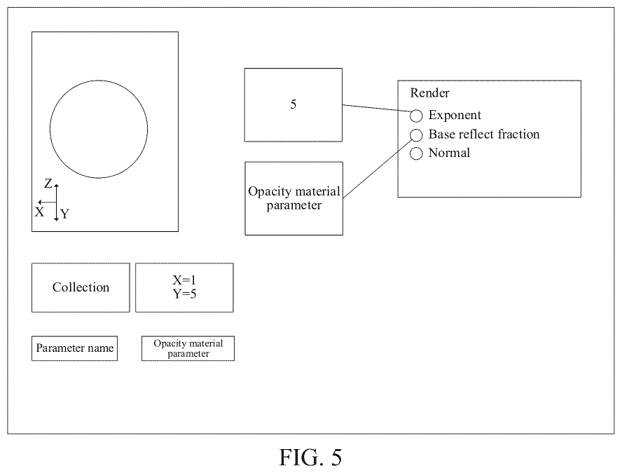

In some embodiments, the terminal may input only an initial value of the target material parameter in the material parameter collection to the renderer of the unreal engine 4, and a candidate target material parameter may use a default parameter value. For example, as shown in FIG. 5, when the initial value of the opacity material parameter is optimized, the initial value of the opacity material parameter is inputted to the renderer of the unreal engine 4. Data types involved in a renderer (Fresnel) in FIG. 5 include an exponent (Exponenth), a base reflect fraction (BaseReflectFraction), and a normal (Normal).

S302: The terminal determines a correlation between the opacity material parameter and the color material parameter, and selects, from the opacity material parameter and the color material parameter according to the correlation, an opacity material parameter as a target material parameter, where the color material parameter serves as a candidate material parameter.

S303: The terminal obtains a photographed image of the target object and determines an illuminance of the photographed image.

S304: The terminal renders the target object according to a set value of a candidate material parameter, an initial value of the target material parameter, and the illuminance, to obtain a rendered image of the target object.

S305: The terminal determines a rendering value corresponding to the target material parameter in the rendered image and a real value corresponding to the photographed image, and determines whether the target material parameter is a color material parameter.

S306: If the target material parameter is not a color material parameter, the terminal determines a difference between the rendering value and the real value, and uses the difference between the rendering value and the real value as difference information between the rendered image and the photographed image.

S307: If the target material parameter is a color material parameter, the terminal performs color space conversion on the rendering value and the real value, to obtain a converted rendering value and a converted real value.

For example, when the rendering value is a color value represented by using an RGB color space, the rendering value may be converted into a color value represented by using an LAB color space. In this case, the rendering value in the RGB color space may be first converted into a candidate rendering value in an XYZ color space, and then the candidate rendering value in the XYZ color space is converted into a converted rendering value in the LAB color space, that is, the rendering value may be substituted into the following formula for conversion, to obtain a converted rendering value:

$$[ \begin{matrix}X \\ Y \\ Z\end{matrix} ] = M [ \begin{matrix}R \\ G \\ B\end{matrix} ]$$

$${L}_{i} = 166 [ f ( \frac{Y}{{Y}_{n}} ) - \frac{16}{116} ]$$

$${a}_{i} = 500 [ f ( \frac{X}{{X}_{n}} ) - f ( \frac{Y}{{Y}_{n}} ) ]$$

$${b}_{i} = 200 [ f ( \frac{Y}{{Y}_{n}} ) - f ( \frac{Z}{{Z}_{n}} ) ]$$

where M represents a conversion matrix, Xₙ, Yₙ, and Zₙ represent white reference points under the CIE1931 standard, Xₙ=95.047, Yₙ=100.0, and Zₙ=108.883, L_{I}, aᵢ, and Bᵢ represent converted rendering values,

$$[ \begin{matrix}X \\ Y \\ Z\end{matrix} ]$$

represents a candidate rendering value, and

$$[ \begin{matrix}R \\ G \\ B\end{matrix} ]$$

represents a rendering value. ƒ( ) is expressed by the following formula:

$$f ( t ) = \{ \begin{matrix}\sqrt[3]{t} & t < 0.008856 \\ 7.787 t + \frac{16}{116} & Others\end{matrix}$$

For a process of converting the real value, reference may be made to the foregoing process of converting the rendering value, and details are not described herein again in this embodiment.

S308: The terminal determines a difference between the converted rendering value and the converted real value, and uses the difference between the converted rendering value and the converted real value as the difference information between the rendered image and the photographed image.

The color material parameter may include three sub-material parameter, and therefore a sub-difference between a converted rendering value and a converted real value of each sub-material parameter may be solved separately, and then the three sub-differences are added, to obtain the difference between the converted rendering value and the converted real value.

That is, the converted rendering value and the converted real value may be substituted into the following formula, to obtain the difference information between the rendered image and the photographed image:

$$Δ L = {L}_{r} - {L}_{i}$$

$$Δ a = {a}_{r} - {a}_{i}$$

$$Δ b = {b}_{r} - {b}_{i}$$

$$Δ E = \sqrt{{( Δ L )}^{2} + {( Δ a )}^{2} + {( Δ b )}^{2}}$$

where ΔL represents a sub-difference between a converted rendering value and a converted real value of a brightness sub-material parameter, Δa represents a sub-difference between a converted rendering value and a converted real value of a red green sub-material parameter, Δb represents a sub-difference between a converted rendering value and a converted real value of a yellow blue sub-material parameter, ΔE represents a difference between a converted rendering value and a converted real value, and Lᵣ, aᵣ, and Bᵣ represents the converted real value.

S309: If the difference information is greater than a preset threshold, the terminal solves a gradient of the difference information for the target material parameter, and obtains an optimization step corresponding to the target material parameter.

S3010: The terminal adjusts an initial value of the target material parameter according to the gradient of the target material parameter and the optimization step corresponding to the target material parameter, to obtain a candidate value.

The terminal may perform multiplication merge processing on the gradient of the target material parameter and the optimization step corresponding to the target material parameter, to obtain an optimization degree of the target material parameter, and then perform addition merge processing on the optimization degree and the initial value, to obtain an optimized candidate value of the target material parameter.

For example, when the target material parameter is a color material parameter, the difference information may be substituted into the following formula for merge processing, to obtain an optimized candidate value of the target material parameter:

$$\begin{matrix}{L}_{k + 1} = {L}_{k} + α \times \frac{\partial Δ E}{\partial L} \\ {a}_{k + 1} = {a}_{k} + β \times \frac{\partial Δ E}{\partial a} \\ {b}_{k + 1} = {b}_{k} + γ \times \frac{\partial Δ E}{\partial b}\end{matrix}$$

where Lₖ₊₁, aₖ₊₁, and bₖ₊₁ represent optimized candidate values of the target material parameter, Lₖ, aₖ, and bₓ represent initial values of the target material parameter,

$$\frac{\partial Δ E}{\partial L}$$

represents a gradient of the difference information of the brightness sub-material parameter, α represents an optimization step of the brightness sub-material parameter,

$$\frac{\partial Δ E}{\partial a}$$

represents a gradient of the difference information of the red green sub-material parameter, β represents an optimization step of the red green sub-material parameter,

$$\frac{\partial Δ E}{\partial b}$$

represents a gradient of the difference information of the yellow blue sub-material parameter, γ represents an optimization step of the yellow blue sub-material parameter, and k represents a number of adjustments.

S3011: The terminal uses the candidate value as the initial value of the target material parameter and returns to perform operation S303.

S3012: If the difference information is less than or equal to the preset threshold, use the initial value as a target value of the target material parameter.

The difference information in the embodiments of this application can also be understood as a loss function value, that is, the rendering value and the real value are substituted into the loss function for calculation, to obtain a loss function value, and the loss function value is used as the difference information.

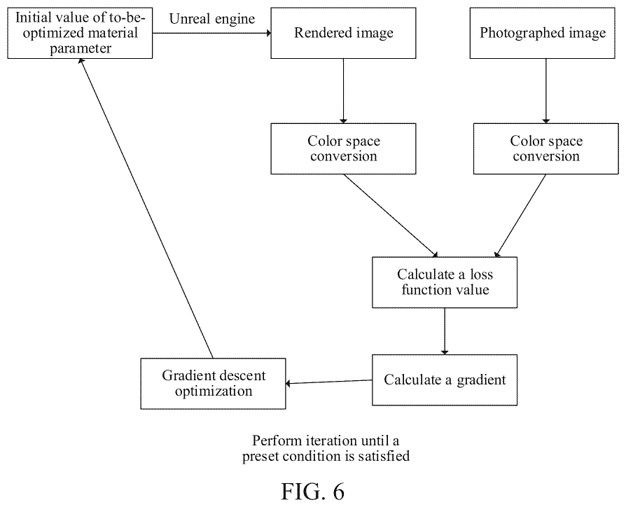

For example, when the target material parameter is a color material parameter, the process of optimizing the material parameter according to the embodiments of this application may be as shown in FIG. 6. After obtaining the initial value of the target material parameter, the terminal inputs the initial value into the unreal engine to render the target object, to obtain a rendered image, then performs color space conversion on the rendering value of the rendered image and the real value of the photographed image respectively, to obtain a converted rendering value and a converted real value, then substitutes the converted rendering value and the converted real value into a loss function, to calculate a loss function value, calculates a gradient of the target material parameter according to the loss function value, optimizes the initial value of the target material parameter according to the gradient descent to obtain the candidate value, and finally continues to optimize the candidate value, until the loss function value satisfies a preset condition.

S3013: The terminal determines an optimization state of the color material parameter.

S3014: If the optimization state of the color material parameter is a to-be-optimized state, the terminal uses a color material parameter as the target material parameter, uses an opacity material parameter as the candidate material parameter, and returns to perform operation S303.

S3015: If the optimization state of the color material parameter is an optimized state, the terminal may render the target object according to the target value of the color material parameter and the target value of the opacity material parameter, to obtain the rendered image of the target object.

In the embodiments of this application, the difference between the rendered image and the photographed image under the same illumination environment is calculated, and then a derivative of the difference with respect to the target material parameter is calculated, and gradient descent optimization is performed. After several rounds of iterative calculation, the rendered image closest to the photographed image can be obtained, so that the target value of the material parameter closest to the photographed image can be obtained.

The effects of the embodiments of this application are described below.

In this embodiment of this application, when the illuminance is 280 lux, 210 lux, 160 lux, 110 lux, and 65 lux, the car paint is photographed, to obtain a photographed image of the car paint, and then the opacity material parameter is optimized according to the photographed image under 280 lux, 210 lux, 160 lux, 110 lux, and 65 lux. When the initial value of the opacity material parameter is 0.2 and the difference information between the rendered image and the photographed image is 4.243824 and less than the preset threshold, the initial value 0.2 is used as the target value of the opacity material parameter.

Similarly, after obtaining the target value of the opacity material parameter, the terminal optimizes the color material parameter according to the photographed image under 280 lux, 210 lux, 160 lux, 110 lux, 65 lux and the target value 0.2 of the opacity material parameter. When the initial value of the color material parameter is 0.86, the difference information between the rendered image and the photographed image is 3.043818 and less than the preset threshold, the initial value 0.86 is used as the target value of the color material parameter.

To better implement the image processing method provided in the embodiments of this application, an embodiment of this application further provides an apparatus based on the foregoing image processing method. Nouns have meanings the same as that in the foregoing image processing method, and for specific implementation details, reference may be made to the description in the method embodiments.

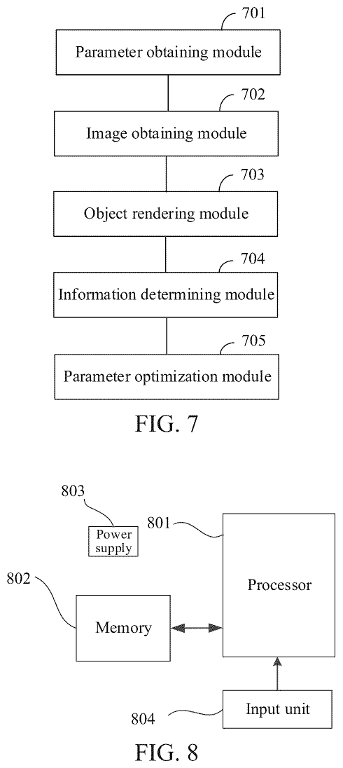

For example, as shown in FIG. 7, the image processing apparatus may include:
a parameter obtaining module 701, configured to obtain a target material parameter of a target object and obtain an initial value of the target material parameter;
an image obtaining module 702, configured to obtain a photographed image of the target object and determine a photographing parameter of the photographed image;
an object rendering module 703, configured to render the target object according to the initial value and the photographing parameter, to obtain a rendered image of the target object;
an information determining module 704, configured to determine difference information between the rendered image and the photographed image according to the rendered image and the photographed image;
a parameter optimization module 705, configured to adjust the initial value according to the difference information, to obtain a target value of the target material parameter, so as to render the target object according to the target value and obtain the rendered image of the target object.

In some embodiments, the information determining module 704 is specifically configured to:
determine a corresponding rendering value of the target material parameter in the rendered image according to the rendered image;
determine a real value of the target material parameter in the photographed image according to the photographed image; and
determine the difference information between the rendered image and the photographed image according to the rendering value and the real value.

In some embodiments, the target material parameter includes at least two sub-material parameters. The rendering value includes a rendering value of each sub-material parameter in the at least two sub-material parameters. The real value includes a real value of each sub-material parameter.

Correspondingly, the information determining module 704 is specifically configured to:
determine sub-difference information between the real value of each sub-material parameter and a rendering value of the sub-material parameter; and
determine the difference information between the rendered image and the photographed image according to pieces of sub-difference information.

In some embodiments, the parameter optimization module 705 is specifically configured to:
obtain a preset condition;
if the difference information dissatisfies the preset condition, adjust the initial value according to the difference information, to obtain a candidate value;
use the candidate value as the initial value of the target material parameter, and return to perform the operation of rendering the target object according to the initial value and the photographing parameter; and
if the difference information satisfies the preset condition, use the initial value as the target value of the target material parameter.

In some embodiments, the parameter optimization module 705 is specifically configured to:
determine an amount of change of the target material parameter according to the difference information; and
adjust the initial value according to the amount of change, to obtain the target value of the target material parameter.

In some embodiments, the parameter optimization module 705 is specifically configured to:
obtain an optimization step corresponding to the target material parameter; and
determine an optimization degree corresponding to the initial value according to the optimization step and the amount of change; and
adjust the initial value according to the optimization degree, to obtain the target value.

In some embodiments, the target material parameter includes a color material parameter.

Correspondingly, the information determining module 704 is specifically configured to:
perform color space conversion on the rendered image, to obtain a converted rendered image;
perform color space conversion on the photographed image, to obtain a converted photographed image; and
determine difference information between the rendered image and the photographed image according to a converted rendered image and a converted photographed image.

In some embodiments, the parameter obtaining module 701 is specifically configured to:
obtain at least two material parameters of the target object; and
select the target material parameter from the at least two material parameters; and

Correspondingly, the object rendering module 703 is specifically configured to:
render the target object according to the initial value, a set value corresponding to the candidate material parameter, and the photographing parameter, to obtain the rendered image of the target object, where the candidate material parameter is a parameter in the at least two material parameters except the target material parameter.

In some embodiments, the parameter obtaining module 701 is specifically configured to:
determine a correlation between the at least two material parameters; and
select the target material parameter from the at least two material parameters according to the correlation.

In some embodiments, the parameter obtaining module 701 is further configured to:
determine an optimization state of the material parameter; and
if the optimization state of the material parameter is a to-be-optimized state, return to perform the operation of selecting the target material parameter from the at least two material parameters.

In some embodiments, during optimization of the at least two target material parameters, the information determining module 704 is specifically configured to:
determine initial difference information between the rendered image and the photographed image for each target material parameter according to the rendered image and the photographed image; and
determine the difference information between the rendered image and the photographed image according to initial difference information corresponding to each target material parameter.

During specific implementation, the foregoing modules may be implemented as independent entities or may be combined in different manners as a same entity or several entities for implementation. For specific implementations of the foregoing modules and corresponding beneficial effects, refer to the foregoing method embodiments. Details are not provided herein again.

The embodiments of this application further provide an electronic device. The electronic device may be a server, a terminal, or the like. FIG. 8 shows a schematic structural diagram of an electronic device involved in the embodiments of this application. The electronic device may include components such as a processor 801 of one or more processing cores, a memory 802 of one or more computer-readable storage media, a power supply 803, and an input unit 804. The electronic device structure shown in FIG. 8 does not constitute a limit to the electronic device. The server may include more or fewer parts than those shown in the figure, may combine some parts, or may have different part arrangements.

The processor 801 is a control center of the electronic device, which is connected to various parts of the entire electronic device by using various interfaces and lines, and by running or executing a computer program and/or module stored in the memory 802 and calling data stored in the memory 802, implements various functions of the electronic device and processes data. In some embodiments, the processor 801 may include one or more processing cores. Preferably, the processor 801 may integrate an application processor and a modem. The application processor mainly processes an operating system, a user interface, an application program, and the like. The modem mainly processes wireless communication. The foregoing modem may be integrated into the processor 801.

The memory 802 may be configured to store a computer program and a module. The processor 801 runs the computer program and module stored in the memory 802, to execute various functional applications and data processing. The memory 802 may mainly include a program storage area and a data storage area. The program storage area may store an operating system, a computer program required by at least one function (for example, a sound playing function and an image playing function), or the like. The storage data area may store data or the like created according to the use of the electronic device. In addition, the memory 802 may include a high speed random access memory, and may alternatively include a non-volatile memory, such as at least one magnetic disk storage device, a flash memory, or another volatile solid-state storage device. Correspondingly, the memory 802 may further include a memory controller, to provide access of the processor 801 to the memory 802.

The electronic device further includes a power supply 803 for supplying power to the various components. Preferably, the power supply 803 may be logically connected to the processor 801 by a power management system, thereby implementing functions such as charging, discharging, and power consumption management by using the power management system. The power supply 803 may further include one or more of a direct current or alternating current power supply, a re-charging system, a power failure detection circuit, a power supply converter or inverter, a power supply state indicator, and any other components.

The electronic device may further include an input unit 804. The input unit 804 may be configured to receive entered numeric or character information and generate keyboard, mouse, joystick, optical, or trackball signal input related to user settings and function control.

Although not shown in the figure, the electronic device may further include a display unit, and the like. Details are not described herein again. Specifically, in this embodiment, the processor 801 in the electronic device may load, according to the following instructions, executable files corresponding to processes of one or more computer programs into the memory 802. The processor 801 runs the computer programs stored in the memory 802, to implement various functions, for example:
obtaining a target material parameter of a target object and obtaining an initial value of the target material parameter;
obtaining a photographed image of the target object and determining a photographing parameter of the photographed image;
rendering the target object according to the initial value and the photographing parameter, to obtain a rendered image of the target object;
determining difference information between the rendered image and the photographed image according to the rendered image and the photographed image; and
adjusting the initial value according to the difference information, to obtain a target value of the target material parameter, so as to render the target object according to the target value and obtain the rendered image of the target object.

For specific implementation of the foregoing operations and corresponding beneficial effects, refer to the foregoing image processing method. Details are not described herein again.

All or some operations of the methods in the foregoing embodiments may be implemented by using a computer program, or implemented through computer program controlling relevant hardware, and the computer program may be stored in a computer-readable storage medium and loaded and executed by a processor.

In view of this, an embodiment of this application provides a non-transitory computer-readable storage medium, having a plurality of computer programs stored, the computer programs being suitable to be loaded by a processor, to implement the operations in any image processing method according to the embodiments of this application. For example, the computer program may perform the following operations:
obtaining a target material parameter of a target object and obtaining an initial value of the target material parameter.
obtaining a photographed image of the target object and determining a photographing parameter of the photographed image;
rendering the target object according to the initial value and the photographing parameter, to obtain a rendered image of the target object;
determining difference information between the rendered image and the photographed image according to the rendered image and the photographed image; and
adjusting the initial value according to the difference information, to obtain a target value of the target material parameter, so as to render the target object according to the target value and obtain the rendered image of the target object.

For specific implementation of the foregoing operations and corresponding beneficial effects, refer to the foregoing embodiments. Details are not described herein again.

The computer-readable storage medium may include: a read-only memory (ROM), a random access memory (RAM), a magnetic disk, an optical disc, or the like.

Since the computer program stored in the computer-readable storage medium may perform the operations of any image processing method provided in the embodiments of this application, the computer program can implement advantageous effects that may be implemented by any image processing method provided in the embodiments of this application. The foregoing embodiments may be referred to for details. Details are not further described herein.

An aspect of this application provides a computer program product or a computer program, the computer program product or the computer program including computer instructions, and the computer instructions being stored in the computer-readable storage medium. A processor of the computer device reads the computer instructions from the computer-readable storage medium, and the processor executes the computer instructions, so that the computer device performs the image processing method.

The image processing method and apparatus, the device, the storage medium, and the program product provided in the embodiments of this application are described in detail foregoing. The principles and implementation of this application are described by applying specific examples, and the descriptions of the embodiments are only used to help understand the method of this application and its core idea. In addition, for a person skilled in the art, there will be changes in the specific embodiments and the application scope according to the idea of this application. In conclusion, the content of the present specification cannot be construed as a limitation to this application. The term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

What is claimed is:

1. An image processing method performed by an electronic device, the method comprising:
obtaining an initial value of a target material parameter of a target object;
determining a photographing parameter of a photographed image of the target object;
rendering the target object according to the initial value and the photographing parameter, to obtain a rendered image of the target object;
determining difference information between the rendered image and the photographed image;
adjusting the initial value according to the difference information, to obtain a target value of the target material parameter; and
updating the rendered image of the target object by rendering the target object according to the target value.

2. The method according to claim 1, wherein the determining difference information between the rendered image and the photographed image comprises:
determining a rendering value of the target material parameter corresponding to the rendered image;
determining a real value of the target material parameter corresponding to the photographed image; and
determining the difference information according to the rendering value and the real value.

3. The method according to claim 1, wherein the adjusting the initial value according to the difference information, to obtain a target value of the target material parameter comprises:
adjusting the initial value according to the difference information, to obtain a candidate value of the target material parameter;
rendering the target object according to the candidate value and the photographing parameter;
determining the difference information between the rendered image and the photographed image;
repeating the adjusting and rendering operations until the difference information satisfies a preset condition; and
using the candidate value as the target value.

4. The method according to claim 1, wherein the adjusting the initial value according to the difference information, to obtain a target value of the target material parameter comprises:
determining an amount of change of the target material parameter according to the difference information;
obtaining an optimization step corresponding to the target material parameter; and
adjusting the initial value according to the optimization step and the amount of change, to obtain the target value.

5. The method according to claim 1, wherein the determining difference information between the rendered image and the photographed image comprises:
performing color space conversion on the rendered image, to obtain a converted rendered image;
performing color space conversion on the photographed image, to obtain a converted photographed image; and
determining the difference information according to the converted rendered image and the converted photographed image.

6. The method according to claim 1, wherein the obtaining an initial value of a target material parameter of a target object comprises:
obtaining at least two material parameters of the target object; and
selecting the target material parameter from the at least two material parameters; and
rendering the target object according to the initial value, a set value corresponding to the candidate material parameter, and the photographing parameter, to obtain the rendered image of the target object, wherein the candidate material parameter is a parameter in the at least two material parameters except the target material parameter.

7. The method according to claim 6, wherein the selecting the target material parameter from the at least two material parameters comprises:
determining a correlation between the at least two material parameters; and
selecting the target material parameter from the at least two material parameters according to the correlation.

8. An electronic device, comprising a processor and a memory, the memory having a computer program stored therein, and the computer program, when executed by the processor, causing the electronic device to implement an image processing method including:
obtaining an initial value of a target material parameter of a target object;
determining a photographing parameter of a photographed image of the target object;
rendering the target object according to the initial value and the photographing parameter, to obtain a rendered image of the target object;
determining difference information between the rendered image and the photographed image;
adjusting the initial value according to the difference information, to obtain a target value of the target material parameter; and
updating the rendered image of the target object by rendering the target object according to the target value.

9. The electronic device according to claim 8, wherein the determining difference information between the rendered image and the photographed image comprises:
determining a rendering value of the target material parameter corresponding to the rendered image;
determining a real value of the target material parameter corresponding to the photographed image; and
determining the difference information according to the rendering value and the real value.

10. The electronic device according to claim 8, wherein the adjusting the initial value according to the difference information, to obtain a target value of the target material parameter comprises:
adjusting the initial value according to the difference information, to obtain a candidate value of the target material parameter;
rendering the target object according to the candidate value and the photographing parameter;
determining the difference information between the rendered image and the photographed image;
repeating the adjusting and rendering operations until the difference information satisfies a preset condition; and
using the candidate value as the target value.

11. The electronic device according to claim 8, wherein the adjusting the initial value according to the difference information, to obtain a target value of the target material parameter comprises:
determining an amount of change of the target material parameter according to the difference information;
obtaining an optimization step corresponding to the target material parameter; and
adjusting the initial value according to the optimization step and the amount of change, to obtain the target value.

12. The electronic device according to claim 8, wherein the determining difference information between the rendered image and the photographed image comprises:
performing color space conversion on the rendered image, to obtain a converted rendered image;
performing color space conversion on the photographed image, to obtain a converted photographed image; and
determining the difference information according to the converted rendered image and the converted photographed image.

13. The electronic device according to claim 8, wherein the obtaining an initial value of a target material parameter of a target object comprises:
obtaining at least two material parameters of the target object; and
selecting the target material parameter from the at least two material parameters; and
rendering the target object according to the initial value, a set value corresponding to the candidate material parameter, and the photographing parameter, to obtain the rendered image of the target object, wherein the candidate material parameter is a parameter in the at least two material parameters except the target material parameter.

14. The electronic device according to claim 13, wherein the selecting the target material parameter from the at least two material parameters comprises:
determining a correlation between the at least two material parameters; and
selecting the target material parameter from the at least two material parameters according to the correlation.

15. A non-transitory computer-readable storage medium having a computer program stored therein, and the computer program, when executed by a processor of an electronic device, causing the electronic device to implement an image processing method including:
obtaining an initial value of a target material parameter of a target object;
determining a photographing parameter of a photographed image of the target object;
rendering the target object according to the initial value and the photographing parameter, to obtain a rendered image of the target object;
determining difference information between the rendered image and the photographed image;
adjusting the initial value according to the difference information, to obtain a target value of the target material parameter; and
updating the rendered image of the target object by rendering the target object according to the target value.

16. The non-transitory computer-readable storage medium according to claim 15, wherein the determining difference information between the rendered image and the photographed image comprises:
determining a rendering value of the target material parameter corresponding to the rendered image;
determining a real value of the target material parameter corresponding to the photographed image; and
determining the difference information according to the rendering value and the real value.

17. The non-transitory computer-readable storage medium according to claim 15, wherein the adjusting the initial value according to the difference information, to obtain a target value of the target material parameter comprises:
adjusting the initial value according to the difference information, to obtain a candidate value of the target material parameter;
rendering the target object according to the candidate value and the photographing parameter;
determining the difference information between the rendered image and the photographed image;
repeating the adjusting and rendering operations until the difference information satisfies a preset condition; and
using the candidate value as the target value.

18. The non-transitory computer-readable storage medium according to claim 15, wherein the adjusting the initial value according to the difference information, to obtain a target value of the target material parameter comprises:
determining an amount of change of the target material parameter according to the difference information;
obtaining an optimization step corresponding to the target material parameter; and
adjusting the initial value according to the optimization step and the amount of change, to obtain the target value.

19. The non-transitory computer-readable storage medium according to claim 15, wherein the determining difference information between the rendered image and the photographed image comprises:
performing color space conversion on the rendered image, to obtain a converted rendered image;
performing color space conversion on the photographed image, to obtain a converted photographed image; and
determining the difference information according to the converted rendered image and the converted photographed image.

20. The non-transitory computer-readable storage medium according to claim 15, wherein the obtaining an initial value of a target material parameter of a target object comprises:
obtaining at least two material parameters of the target object; and
selecting the target material parameter from the at least two material parameters; and
rendering the target object according to the initial value, a set value corresponding to the candidate material parameter, and the photographing parameter, to obtain the rendered image of the target object, wherein the candidate material parameter is a parameter in the at least two material parameters except the target material parameter.
